(19) United States
(12) Patent Application Publication
(10) Pub. No.: US 2025/0132113 A1
(43) Pub. Date: Apr. 24, 2025

(54) Electrical Contactor Comprising a Movable Element

(71) Applicant: ABB Schweiz AG, Baden (CH)

(72) Inventors: Vincent Parniere, Caluire (FR); Yoann Granier, Vienne (FR)

(73) Assignee: ABB Schweiz AG, Baden (CH)

(21) Appl. No.: 18/918,404

(22) Filed: Oct. 17, 2024

(30) Foreign Application Priority Data
Oct. 19, 2023 (EP) 23204657.3

(51) Int. Cl. H01H 45/02

(52) U.S. Cl. CPC H01H 45/02; H01H 2203/04

(57) ABSTRACT

An electrical contactor includes a contactor housing having at least one access portion configured to receive and guide at least one two-threaded screw, wherein the access portion comprises a first screw reception portion configured to receive at least one first screw thread of the screw, wherein the contactor housing further comprises at least one movable element arranged at the access portion and comprising a second screw reception portion configured to receive at least one second screw thread of the screw different to the first screw thread, and wherein the movable element is movable along a screwing axis.

### CROSS-REFERENCE TO RELATED APPLICATIONS

The instant application claims priority to European Patent Application No. 23204657.3, filed Oct. 19, 2023, which is incorporated herein in its entirety by reference.

### FIELD OF THE DISCLOSURE

The present disclosure generally relates to an electrical contactor, a movable element and an electrical contactor assembly.

### BACKGROUND OF THE INVENTION

In classical electrical contactors, an electrical cable can be connected and secured by a screw for establishing an electrical connection. However, using a common screw with only one thread and a corresponding reception may not be sufficient in certain application areas. Accordingly, some contactors use two-threaded screws are used. However, the employment of such screws is often accompanied with further problems regarding an alignment, in particular during screwing-in and screwing-out due to the more complex nature of the screw and the respective one or more receptions. This may lead to undesired canting and the occurrence of undesired forces during screwing operation, thus potentially leading to damages of the electrical contactor and/or the screw.

### BRIEF SUMMARY OF THE INVENTION

The present disclosure generally relates to an electrical contactor comprising a contactor housing. The contactor housing comprises at least one access portion configured to receive and guide at least one two-threaded screw. The access portion comprises a first screw reception portion configured to receive at least one first screw thread of the screw. The contactor housing further comprises at least one movable element arranged at the access portion. The movable element comprises a second screw reception portion configured to receive at least one second screw thread of the screw, different to the first screw thread.

The movable element is movable in the contactor housing along a screwing axis. Thus, the electrical contactor according to the present disclosure may allow aligning, along the screwing axis, the first screw reception portion and the first screw thread of the screw. Likewise, the electrical contactor according to the present disclosure may allow for aligning, along the screwing axis, the second screw reception portion and the second screw thread of the screw. Thus, a potential misalignment of the respective parts may be prevented. Accordingly, any constraints originating thereof may be absorbed by a suitable movement of the movable element.

### BRIEF DESCRIPTION OF THE SEVERAL VIEWS OF THE DRAWING(S)

For a better understanding of the present disclosure, and to illustrate its practicality, figures are provided in the following and reference is made thereto. It should be understood that the figures represent only exemplary embodiments and thus in no way limit the scope of the claimed invention. Identical or like-acting elements are indicated throughout by the same reference signs. Any reference signs in the claims should not be construed as limiting the scope of the claims. In the drawings, reference signs may be partially omitted to ensure a proper representability of the depicted embodiments.

FIG. 1 is a schematic of an electrical contactor according to the present disclosure.

FIG. 2 is a partial view of a schematic of an electrical contactor assembly according to the present disclosure.

FIG. 3 is a schematic of a movable element according to the present disclosure.

### DETAILED DESCRIPTION OF THE INVENTION

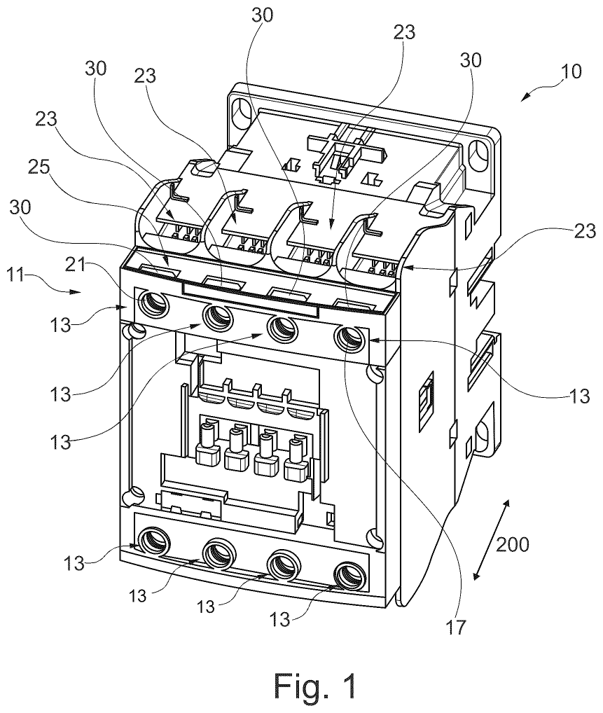

FIG. 1 depicts an electrical contactor 10 according to the present disclosure comprising a contactor housing 11. The contactor housing 11 comprises four access portions 13 at the top side and four further access portions 13 at the bottom side, which are each configured to receive and guide an at least two-threaded screw 50. The contactor housing 11 comprises four movable elements 30 arranged at the respective top side access portions 13. Likewise, also the bottom side access portions 13 comprise respective movable elements 30 (not visible in the depicted view). Of course, in different embodiments, the electrical contactor 10 may comprise a different number of access portions 13 and respective movable elements 30, for instance one, two, three, four, five, six, seven, nine or more access portions 13 and respective movable elements 30.

Each of the movable elements 30 comprises a second screw reception portion 17 with a second reception thread 21 adapted to receive a respective screw 50. Further, each of the movable elements 30 comprises a respective a movable element housing portion 25 to allow an insertion of the movable element 30. The insertion the movable element 30 is performed by inserting the movable element 30 via a respective opening, here at the top side, of the contactor housing 11.

Once the movable element 30 is inserted in the movable element housing portion 25, the movable element 30 is held in the movable element housing portion 25 such that it cannot move in a direction perpendicular to a screwing axis 200. The screwing axis 200 defines a direction, along which the screw 50 can be received by the second screw reception portion 17. When the screw 50 is screwed-in, the screw 50 is guided further into the electrical contactor 10. Likewise, the screwing axis 200 defines a direction, at which the screw 50 can be removed from the second screw reception portion 17. The depicted embodiment, the screwing axis 200 extends from the front side to the backside of the electrical contactor 10. However, it is clear that, dependent on the configuration of the electrical contactor, the screwing axis 200 can be defined in a completely different manner, for instance from the top side to the bottom side of the electrical contactor 10. When the screw 50 is screwed-out, the screw 50 is guided out of the electrical contactor 10. In the depicted embodiment, the screw 50 can be received from the front side of the contactor housing 11.

A movement of the movable element 30 perpendicular to the screwing axis 200 is prevented when the movable element 30 is housed in the movable element housing portion 25. Thus, a screw 50, which is received by the second screw reception portion 17, is accordingly aligned in a plane perpendicular to the screwing axis 200. The movable element 30 is however allowed to move in the movable element housing portion 25 along the screwing axis 200, i.e. in a screwing or unscrewing direction of the screw 50. Thus, a screw 50, which is received by the second screw reception portion 17, can be accordingly aligned along the screwing axis 200.

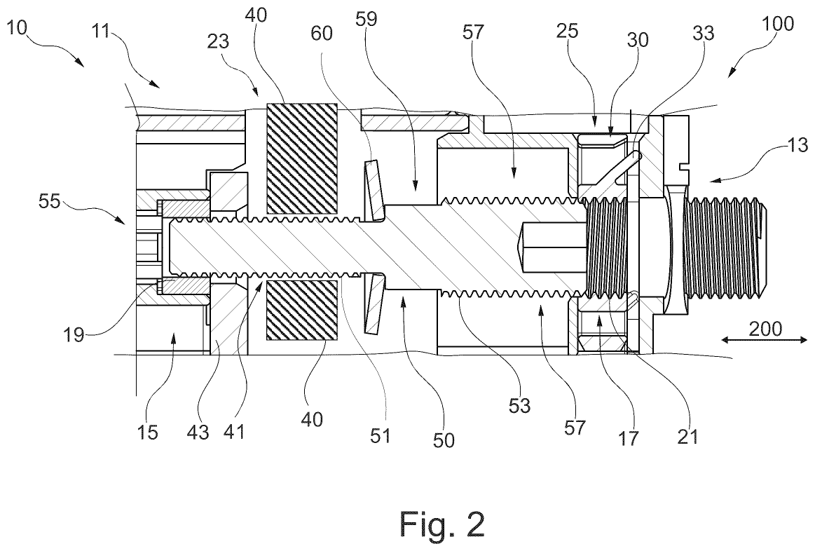

FIG. 2 schematically illustrates a partial cut view of an electrical contactor assembly 100 according to the present disclosure comprising an electrical contactor 10 and a two-threaded screw 50. The electrical contactor 10 comprises a contactor housing 11 and an access portion 13. The access portion 13 comprises a first screw reception portion 15 at a distal side of the access portion 13, which is a side arranged towards an inner side of the electrical contactor 10, and a second screw reception portion 17 at a proximal side of the access portion 13, which is a side arranged towards an outer side of the electrical contactor 10.

A two-threaded screw 50 is depicted having two different threads, which can be screwed into the contactor housing 11 towards the left side. The screw comprises a first screw thread 51, which is arranged at a distal screw end 55, which may be also referred to as screw body, and a second screw thread 53, which is arranged at a proximal screw end 57, and which may be also referred to as screw head. In the depicted embodiment, the first screw thread 51 and the second screw thread 53 are separated and spaced by an intermediate screw portion 59, which comprises no thread.

The second screw reception portion 17 comprises a second reception thread 21, which is formed to receive the second screw thread 53. The first screw reception portion 15 comprises a first reception thread 19, which is formed to receive the first screw thread 51. In the depicted embodiment, the screw 50 is screwed into the first reception thread 19. Herein, the screw 50 is in a first screw holding position, wherein the screw 50 is received by the first screw reception portion 15. In a different position, which is not depicted, and which may be referred to a second screw holding position, the screw is not located at the left side but at the right side of the access portion 13, such that the second screw reception portion 17 engages and holds the screw 50 instead of the first screw reception portion 15.

A cable 40 is housed in a cable reception portion 23. In the depicted embodiment, the cable 40 is inserted from the top side to the contactor housing 11. The cable 40 comprises a cable bore 41 through which the distal screw end 55 can be inserted. Thus, in the first screw holding position, when the distal screw end 55 is inserted through the cable bore 41 and the first screw thread 51 is received by the first reception thread 19 of the first screw reception portion 15, the electrical cable 40 cannot be removed from the contactor housing 11. In the depicted embodiment, the screw 50 is in an intermediate position, wherein the first screw thread 51 is already received by the first reception thread 19, but wherein the screw 50 is not fully screwed-in towards the left side. As depicted, the cable 40 is not in contact with a fix electrical contact 43 arranged in the contactor housing 11.

When the screw 50 is further screwed towards the left side, the washer 60 is pressed by the screw 50 against the electrical cable 40, which accordingly presses the electrical cable 40 to the fix electrical contact 43 to establish an electrical connection. This may also be referred to as a “closed position”. Thus, the electrical cable 40 cannot be removed from the cable reception portion 23. In case no cable 40 is inserted, the closed position accordingly prevents that a cable 40 could be inserted. In the depicted embodiment, the fix electrical contact 43 comprises a bevel at the right side facilitating an insertion of the screw 50.

In the second screw holding position, when the distal screw end 55 is not inserted through the cable bore 41, and when the first thread 51 is not received by the first reception thread 19 of the first screw reception portion 15, the electrical cable 40 is not fixed within the contactor housing 11. Thus, the electrical cable 40 can be removed from or inserted to the cable reception portion 23. This may also be referred to as an “open position”. In this position, the screw 50 is held by an engagement of the second reception thread 21 with the second screw thread 53.

When the screw 50 is screwed-in from the right side to the left side, the second screw thread 53 is initially received by the second screw reception portion 17 and guided via the second reception thread 21 along the access portion 13 of the contactor housing 11 and along the screwing axis 200. When the screw 50 is screwed-in further, the first screw thread 51 approaches and contacts the first reception thread 19 of the first screw reception portion 15. It is noted that in this case the screw 50 is still engaged with the second reception thread 21 and accordingly driven forwards. The first screw thread 51 may however not be immediately receivable by the first reception thread 19 due to a misalignment of the first screw thread 51 with respect to the first reception thread 19. Thus, the first screw thread 51 contacts the first reception thread 19 without being properly received. Thus, a pushing force builds up, which is applied from the first screw thread 51 to the first reception thread 19, since the screw 50 is moved forwards along the screwing axis 200 by the engagement of second reception thread 21 with the second screw thread 53. This force can be however absorbed by the movable element 30, housed in the movable element housing portion 25. The movable element 30 is housed in the movable element housing portion 25 with a certain space or play that allows a movement or deflection of the movable element 30 along the screwing axis 200 towards the right side. Of course, in a different embodiment, a movement or deflection of the movable element 30 may be allowed along the screwing axis 200 to the left side.

In the depicted embodiment, the movable element 30 comprises flexible members 33 in form of flexible arms contacting an inner surface of the movable element housing portion 25. The force applied to the movable element due to non-alignment leads to a deflection of the movable element 30 to the right side until the first screw thread 51 and the first reception thread 19 are aligned. Once the first screw thread 51 is aligned with the first reception thread 19, the first reception thread 19 can receive the first screw thread 51 and the screw 50 can be accordingly further screwed-in along the screwing axis 200. Finally, when screwing-in further, the second screw thread 53 disengages the second screw reception portion 17 such that the screw 50 is then only engaged at the first screw reception portion 15. Thus, no pushing force is applied any longer.

The movable element 30 then accordingly returns to its original position in the movable element housing portion 25. Thus, the movable element 30 allows aligning, along the screwing axis 200, the first screw thread 51 with the first reception thread 19.

When the screw 50 is screwed-out from the left side to the right side, the second screw thread 53 approaches and contacts the second reception thread 21 of the second screw reception portion 17. It is noted that in this case the screw 50 is still engaged with the first reception thread 19 and accordingly driven forwards. The second screw thread 53 may however not be immediately receivable by the second reception thread 21 due to a misalignment of the second screw thread 53 with respect to the second reception thread 21. Thus, the second screw thread 53 contacts the second reception thread 21 without being properly received. Thus, a pushing force builds up, which is applied from the second screw thread 53 to the second reception thread 21, since the screw 50 is moved forwards along the screwing axis 200 by the engagement of first reception thread 19 with the first screw thread 51. This force can be however absorbed by the movable element 30, housed in the movable element housing portion 25. The movable element 30 is housed in the movable element housing portion 25 with a certain space or play that allows a movement or deflection of the movable element 30 along the screwing axis 200 towards the right side. Of course, in a different embodiment, a movement or deflection of the movable element 30 may be allowed along the screwing axis 200 to the left side.

The force applied to the movable element due to non-alignment, which leads to a deflection of the movable element 30 to the right side until the second screw thread 53 and the second reception thread 21 are aligned. Once the second screw thread 53 is aligned with the second reception thread 21, the second reception thread 21 can receive the second screw thread 53 and the screw 50 can be accordingly further screwed-out along the screwing axis 200. Finally, when screwing-out further, the first screw thread 51 disengages the first screw reception portion 19 such that the screw 50 is then only engaged at the second screw reception portion 15. Thus, no pushing force is applied any longer.

The movable element 30 then accordingly returns to its original position in the movable element housing portion 25. Thus, the movable element 30 allows aligning, along the screwing axis 200, the second screw thread 53 with the second reception thread 21. Further, a washer 60 is provided, which contacts the screw 50 at a certain screw position.

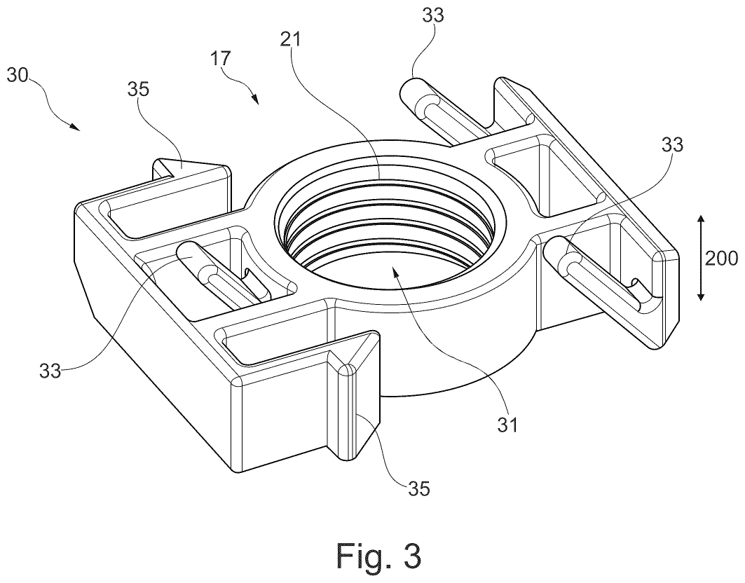

FIG. 3 schematically shows a movable element 30 according to the present disclosure. The movable element comprises a bore 31 or whole, e.g. a through-hole, forming the second reception portion 17 with the second reception thread 21. The depicted embodiment, a screwing axis 200 is in a vertical direction. In the movable element 30 comprises flexible members 33, which are accordingly shaped to allow deflection of the movable element 30 when it is arranged in the movable element housing portion 25. The depicted embodiment the flexible members 33 are formed as three arms extending in 45° from the movable element 30.

However, it will be understood that also completely different shapes and arrangements of one or more flexible members 33 may be provided to obtain a suitable deflection of the movable element 30. The movable element 30 also comprises locking members 35, which allow an insertion of the movable element 30 and a locking of the movable element 30 in the movable element housing portion 25. Thus, when housed in the movable element housing portion 25, the movable element 30 can no longer be moved in a plane perpendicular to the screwing axis 200.

An electrical contactor according to the present disclosure may be any contactor or connector that allows establishing an electrical connection between different electrically conducting parts and may include high-voltage or low-voltage electrical contactors.

The contactor housing may enclose at least partially the respective parts of the electrical contactor to protect the housed components from any negative impacts such as an ingress of, for instance, dust and moisture. The contactor housing may be made of any suitable material, e.g. any suitable insulating materials, and may be formed integrally in one price or may be composed by separate parts that can be connected to each other, for instance via respective clips or screws to form the contactor housing. The contactor housing may be made of a plastic raw material, which may comprise, for instance, a flexural modulus of 11800 MPa or 10500 MPa.

The access portion may be formed as an elongated cavity with an opening at the outer surface of the contactor housing, which may allow to reach a screw from outside of the contactor housing, for instance via a tool means to turn the screw. The screw may be provided in a captive manner in the contactor housing.

One or more access portions may be provided at the electrical contactor configured to receive and guide respective one or more screws towards an inner side of the contactor housing. The access may accordingly provide a space in the contactor housing in which the screw can be moved and guided. The access portion may be formed to guide a screw towards the inside of the contactor housing along the screwing axis. The screwing axis may be the axis along which the screw may be screwed-in and/or screwed-out. Likewise, the access portion may be formed to allow guiding a screw from the inside towards the outside of the contactor housing along the screwing axis. The access portion may be formed by a single part or may be formed by multiple parts being accordingly arranged with respect to each other in the contactor housing.

The first screw reception portion may provide a correspondingly formed cavity or hole in the contactor housing adapted to receive the first screw thread of a double-threaded screw. Upon reception, a snuggly fit of the screw may be provided in the first screw reception portion. The first screw reception portion may be formed as an integral part of the contactor housing or may be formed as a separate part accordingly arranged in the contactor housing. For instance, the first screw reception portion may be formed by a nut that is arranged in the contactor housing. The first screw reception portion may be accordingly arranged to allow a guidance of the screw along the access portion.

One or more movable elements may be provided. The movable element may be movable or deflectable by forces occurring due to a temporal misalignment of the first screw reception portion and the first screw thread and/or the second screw reception portion and the second screw thread. The movable element may be accordingly arranged at the access portion such that the second screw thread of a double-threaded screw could be received by the second screw reception portion defined by the movable element.

The second screw reception portion may provide a correspondingly formed cavity or hole in the contactor housing adapted to receive the second screw thread of the double-threaded screw. Upon reception, a snuggly fit of the screw may be provided in the second screw reception portion. The second screw reception portion may be formed as an integral part of the movable element or may be formed as a separate part, which may be accordingly arranged at the movable element. The second screw reception portion may be accordingly arranged to allow a guidance of the screw along the access portion.

A movement or deflection of the movable element along the screwing axis may be allowed in a range such that it absorbs a temporal misalignment of the first screw reception portion and the first screw thread and the second screw reception portion and the second screw thread. A movement may be allowed at least, for instance, in the range of the pitch of the screw threads. The movement of the movable element may be an elastic movement, such that the movable element may be initially provided at a distinct position along the screwing axis. Upon misalignment of one or more threads and the respective reception portions, the movable element may then be deflected. Finally, the movable element may return to its initial position when the screw threads and the respective reception portions are aligned again.

In a preferred embodiment, the first screw reception portion comprises a first reception thread adapted to receive and fit to the first screw thread, and the movable element comprises a bore with a second reception thread forming the second screw reception portion and adapted to receive the second screw thread. Thus, a particular strong reception of the screw with the contactor housing can be ensured. The reception of the screw by the first screw thread may be a fitting reception such that the outer first thread of the screw perfectly fits to the first reception thread of the first screw reception portion. Likewise, the reception of the screw by the second screw thread may be a fitting reception such that the outer second thread of the screw perfectly fits to the second reception thread of the second screw reception portion. The respective threads may be accordingly aligned in dimensioning and pitch.

In a preferred embodiment, the movable element is configured to movably align, along the screwing axis, the first screw thread with the first reception thread and/or the second screw thread with the second reception thread. Thus, a suitable alignment of the movable element along the same axis as the extension and screwing axis of the screw may be ensured. Thus, undesired forces that may occur due to a misalignment of the respective screw threads with the respective reception threads could be prevented. This may facilitate the engagement of the parts and prevents damages at the respective threads of the contactor housing and the screw. The access portion may be configured to guide the screw in the contactor housing along the screwing axis.

In a preferred embodiment, no further means are provided at the electrical contactor to movably align, along the screwing axis, the first screw thread with the first reception thread and/or the second screw thread with the second reception thread. Thus, a simple and robust electrical contactor may be provided because no further additional means may be necessary to align the screw with the respective first and second reception threads along the screwing axis. This may also facilitate the manufacturing of the electrical contactor.

In a preferred embodiment, a movement of the movable element is blocked in a plane perpendicular to the screwing axis. Thus, the screw, which may be accordingly guided by the movable element, may be prevented from being screwed-in or screwed-out in a wrong orientation or direction. Thus, it may be ensured that the screw may properly reach its final position in the contactor housing. A blocking may be achieved by respective blocking means provided at the movable element, for instance by respective arms or protrusions that contact and interact with the contactor housing for keeping the movable element in a defined position.

In a preferred embodiment, the movable element comprises at least one flexible member configured to elastically deform for allowing a movement of the movable element along the screwing axis. Thus, the defined movement of the movable element may be achieved by defining the flexible member accordingly in shape and material. One or more flexible members may be provided for allowing a proper elastic of deformation and deflection of the movable element. The number, form and shape of the flexible members may depend on the desired restoring forces to be provided and the dimensioning of the flexible member and the employed screw and threads provided. For instance, three flexible arms comprising an approximately 45° extension from the plane perpendicular to the screwing axis may be provided, wherein the arms may be sufficiently clastic to allow an elastic deflection.

In a preferred embodiment, the movable element and the flexible member are integrally formed. Thus, a particular simple and robust movable element may be provided. Accordingly, also the manufacturing of the movable element may be facilitated. However, the flexible members may also not be integrally formed but be provided as separate members attached to the movable element. Further, the flexible member may not be provided at the movable element but at the housing.

In a preferred embodiment, the movable element is formed by an elastically deformable material. Thus, the stiffness and/or elasticity of the movable element may be accordingly adjusted as desired. On the one hand, sufficient stability for guiding the screw may be provided. On the other hand, sufficient flexibility for a movement or deflection is ensured. The movable element may be made of the same material as the contactor housing or may be made of the different material. Furthermore, the color of the movable element may be suitably adapted to allow, for instance, provide a color different to the color of the contactor housing. The movable element may be made, for instance, of a plastic raw material, which may comprise a flexural modulus of, for instance, 11800 MPa or 10500 MPa.

In a preferred embodiment, the contactor housing further comprises at least one cable reception portion configured to receive at least one electrical cable in the contactor housing. Thus, an electrical cable may be received and housed properly in the cable reception portion. One or more cable reception portions may be provided to receive each one or more electrical cables. The cable reception portion may accordingly allow an end of a cable to be inserted from the outside of the contactor housing and may be dimensioned to snugly fit and hold an outer surface of the electrical cable.

In a preferred embodiment, the cable reception portion and the first screw reception portion are arranged and configured to lock the electrical cable in the cable reception portion when the electrical cable is inserted in the cable reception portion and when the screw is received by the first screw reception portion. Thus, the electrical contactor may provide a safe and reliable seat or hold of the electrical cable or a respective ferrule, terminal etc., such as for instance an annular terminal, or similar element potentially provided at the end of the cable, which may be accordingly inserted in the cable reception portion. This may be particularly useful for applications, which require an electrical contactor that provides an improved hold of an electrical cable in the electrical contactor. For instance, the electrical cable may comprise a ring thong ferrule having a bore or hole, e.g. a through-hole, through which the screw can be inserted. Thus, once the first screw reception portion receives the screw, which has been also inserted through the bore of the cable, a removal of the electrical cable may be prohibited.

In a preferred embodiment, the contactor housing comprises at least one movable element housing portion to allow an insertion and for removal of the movable element in the contactor housing and the movable element preferably forms a part of the access portion when it is inserted movable element housing portion. Thus, the proper reception of the movable element at the contactor housing may be provided. One or more movable element housing portions may be provided at the electrical contactor, as desired. The movable element housing portion may be dimensioned to allow a fixation of the movable element in a plane perpendicular to the screwing direction. At the same time, the movable element housing portion may be dimensioned to allow a certain play for the movable element for moving or deflecting along the screwing axis for allowing an alignment of the threads of the screw with the respective receptions of the electrical contactor. The movable element may be removably or non-removably insertable at the movable element housing portion, as desired.

In a preferred embodiment, the first screw reception portion is configured to define a first screw holding position at which the screw can be engaged and held along the screwing axis, and the second screw reception portion is configured to define a second screw holding position at which the screw can be engaged and held along the screwing axis. Thus, the electrical contactor may provide clearly distinguishable positions for the screw during screwing operation. This may provide a facilitated operation for a user. For instance, the screw may provide a second screw holding position, which may be an open position, at which the insertion of an electrical cable is still allowed. The screw may likewise provide a first screw holding position, which may be a closed position, in which the screw may secure an electrical cable in the contactor housing. Thus, an electrical connection may be established with further elements.

In a preferred embodiment, the first screw reception portion and the second screw reception portion are arranged and configured such that, when the screw is held in the first screw holding position, the screw contacts only the first screw reception portion or the first screw reception portion and the second screw reception, and/or when the screw is held in the second screw holding position, the screw contacts only the second screw reception portion or the first screw reception portion and the second screw reception portion. Thus, dependent on the configuration and arrangement of the first and second screw reception portions and their respective contact with the screw, the engagement of the screw can be flexibly adapted to the requirements of the electrical contactor.

The present disclosure further relates to a movable element that can be arranged at the access portion of an electrical contactor according to the present invention as described herein, wherein the movable element comprises a second screw reception portion configured to receive at least one second screw thread of a two-threaded screw, different to at least one first screw thread of the screw, and wherein the movable element is movable along a screwing axis.

The provision of the movable element according to the present disclosure at an electrical contactor may allow employing two-threaded screws in an electrical contactor housing without the drawbacks during screwing and unscrewing due to a misalignment along a screwing axis. Furthermore, by providing a movable element, the material and the thickness of diameter of the screw to be held can easily be adapted, as desired.

The present disclosure further relates to an electrical contactor assembly comprising an electrical contactor according to the present disclosure as described herein, and at least one at least two-threaded screw formed to be receivable and guidable by an access portion of a contactor housing of the electrical contactor, wherein the screw comprises at least one first screw thread and at least one second screw thread, different to the first screw thread.

Thus, an easy operable and alignable electrical contactor assembly employing one or more two-threaded screws may be provided. The at least two-threaded screw may comprise two or more threads at its outer surface. The respective threads may be different or equal in an extension along the screw and may be spaced or not spaced from each other along the outer surface of the screw. The screw may have any suitable material, size and diameter, e.g. normed, such as, for instance M3.5 or M5. Further, the screw may also have any suitable pitch, such as, for instance, 0.6 or 0.8.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SIGNS

10 electrical contactor
11 contactor housing
13 access portion
15 first screw reception portion
17 second screw reception portion
19 first reception thread
21 second reception thread
23 cable reception portion
25 movable element housing portion
30 movable element
31 movable element bore
33 flexible member
35 locking member
40 electrical cable
41 cable bore
43 fix electrical contact
50 two-threaded screw
51 first screw thread
53 second screw thread
55 distal screw end
57 proximal screw end
59 intermediate screw portion
60 washer
100 electrical contactor assembly
200 screwing axis

What is claimed is:

1. An electrical contactor, comprising:
a contactor housing comprising at least one access portion configured to receive and guide at least one two-threaded screw;
wherein the access portion comprises a first screw reception portion configured to receive at least one first screw thread of the screw;
wherein the contactor housing further comprises at least one movable element arranged at the access portion and comprising a second screw reception portion configured to receive at least one second screw thread of the screw, which is different than the first screw thread; and
wherein the movable element is movable along a screwing axis.

2. The electrical contactor according to claim 1, wherein the first screw reception portion comprises a first reception thread adapted to receive and fit to the first screw thread, and wherein the movable element comprises a bore with a second reception thread forming the second screw reception portion and adapted to receive the second screw thread.

3. The electrical contactor according claim 2, wherein the movable element is configured to movably align the first screw thread with the first reception thread along the screwing axis.

4. The electrical contactor according to claim 2, wherein the moveable element is configured to movably align the second screw thread with the second reception thread along the screwing axis.

5. The electrical contactor according to claim 3, wherein movably aligning the first screw thread with the first reception thread along the screwing axis is accomplished solely by the movable element.

6. The electrical contactor according to claim 4, wherein movably aligning the second screw thread with the second reception thread along the screwing axis is accomplished solely by the moveable element.

7. The electrical contactor according to claim 1, wherein a movement of the movable element is blocked in a plane perpendicular to the screwing axis.

8. The electrical contactor according to claim 1, wherein the movable element comprises at least one flexible member configured to elastically deform for allowing a movement of the movable element along the screwing axis.

9. The electrical contactor according to claim 8, wherein the movable element and the flexible member are integrally formed.

10. The electrical contactor according to claim 1, wherein the movable element is formed by an elastically deformable material.

11. The electrical contactor according to claim 1, wherein the contactor housing further comprises at least one cable reception portion configured to receive at least one electrical cable in the contactor housing.

12. The electrical contactor according to claim 11, wherein the cable reception portion and the first screw reception portion are arranged and configured to lock the electrical cable in the cable reception portion when the electrical cable is inserted in the cable reception portion and when the screw is received by the first screw reception portion.

13. The electrical contactor according to claim 1, wherein the contactor housing comprises at least one movable element housing portion to allow an insertion and/or removal of the movable element in the contactor housing, and wherein the movable element forms a part of the access portion when it is inserted into the movable element housing portion.

14. The electrical contactor according to claim 1, wherein the first screw reception portion is configured to define a first screw holding position at which the screw can be engaged and held along the screwing axis, and wherein the second screw reception portion is configured to define a second screw holding position at which the screw can be engaged and held along the screwing axis.

15. The electrical contactor according to claim 14, wherein the first screw reception portion and the second screw reception portion are arranged and configured such that, when the screw is held in the first screw holding position, the screw contacts only the first screw reception portion or the first screw reception portion and the second screw reception, and/or when the screw is held in the second screw holding position, the screw contacts only the second screw reception portion or the first screw reception portion and the second screw reception portion.

16. A movable element that is configured to be disposed at an access portion of an electrical contactor, the electrical contactor comprising:
a contactor housing comprising the access portion, which access portion is configured to receive and guide at least one two-threaded screw;
wherein the access portion comprises a first screw reception portion configured to receive at least one first screw thread of the screw;
wherein the contactor housing further comprises at least one movable element arranged at the access portion and comprising a second screw reception portion configured to receive at least one second screw thread of the screw, which is different than the first screw thread; and
wherein the movable element is movable along a screwing axis.

17. An electrical contactor assembly, comprising:
a contactor housing comprising an access portion, which access portion is configured to receive and guide at least one two-threaded screw;
wherein the access portion comprises a first screw reception portion configured to receive at least one first screw thread of the screw;
wherein the contactor housing further comprises at least one movable element arranged at the access portion and comprising a second screw reception portion configured to receive at least one second screw thread of the screw, which is different than the first screw thread; and
wherein the movable element is movable along a screwing axis.
